(19) United States
(12) Patent Application Publication
(10) Pub. No.: US 2025/0076186 A1
(43) Pub. Date: Mar. 6, 2025

(54) LIGHT INTENSITY CONTROLLER AND LASER WAVELENGTH SCANNING DOUBLE-BEAM SPECTROMETER

(71) Applicant: Government of the United States of America, as represented by the Secretary of Commerce, Gaithersburg, MD (US)

(72) Inventor: Young Jong Lee, Gaithersburg, MD (US)

(21) Appl. No.: 18/951,322

(22) Filed: Nov. 18, 2024

Related U.S. Application Data
(63) Continuation-in-part of application No. 18/514,008, filed on Nov. 20, 2023.
(60) Provisional application No. 63/426,486, filed on Nov. 18, 2022.
(60) Provisional application No. 63/599,785, filed on Nov. 16, 2023.

(51) Int. Cl. G01N 21/25; G01N 21/27

(52) U.S. Cl. CPC G01N 21/256; G01N 21/255; G01N 21/27; G01N 2201/06113; G01N 2201/0636

(57) ABSTRACT

A spectrometer includes a light source and a digital micromirror device (DMD) that splits light from the light source to control an intensity of light directed at a sample. The intensity of the light may be controlled in order to smooth an intensity of light through a sample without analyte based on differential wavelength absorption. Alternatively, the intensity of light may be modulated in conjunction with an out-of-phase reference beam to create a simplified double-beam spectrometer with a single light source and a single detector.

### RELATED APPLICATIONS

This application claims the benefit of U.S. Provisional Patent Application Ser. No. 63/599,785 (filed Nov. 16, 2023), which is herein incorporated by reference in its entirety.

This application is a continuation-in-part and claims benefit of the following application: U.S. patent application Ser. No. 18/514,008 filed Nov. 20, 2023 which claims the benefit of U.S. Provisional Patent Application Ser. No. 63/426,486 (filed Nov. 18, 2022). All patents, patent applications, and publications cited herein are hereby incorporated by reference in their entirety.

### FEDERALLY-SPONSORED RESEARCH AND DEVELOPMENT

This invention was made with United States Government support from the National Institute of Standards and Technology (NIST), an agency of the United States Department of Commerce. The Government has certain rights in this invention.

### COPYRIGHT NOTICE

This patent disclosure may contain material that is subject to copyright protection. The copyright owner has no objection to the facsimile reproduction by anyone of the patent document or the patent disclosure as it appears in the U.S. Patent and Trademark Office patent file or records, but otherwise reserves any and all copyright rights.

### FIELD OF INVENTION

The present invention relates generally to spectroscopy, and more particularly to micro-mirror utilization for controlling light sources for spectroscopy.

### BACKGROUND

Absorption spectrometry is based on the measurement of transmission spectra through an analyte and a reference.

### SUMMARY OF INVENTION

A double-beam path configuration can improve the signal-to-noise ratio (SNR) of a spectrometer by measuring the ratio or the difference between the sample path and the reference path signals. A beam from a single light source is split into two beams, wherein one beam passes through a sample while the other passes through a reference. By detecting the two beam signals simultaneously, one can eliminate the common signal fluctuations in the two beams and measure only the analyte signals in the sample path. In some applications, wavelength-scanning monochromatic light is used as the light source for a double-beam spectrometer. An absorption or transmission spectrum can be measured by detecting the two beam signals with fast and sensitive single-element detectors while the wavelength is scanned.

However, when a solvent has a strong absorption at a narrow wavelength range, the limited dynamic range of the detection system cannot cover the entire wavelength range of a spectrum, resulting in extremely poor SNR at the solvent-absorbing wavelength range. Some technology for solvent absorption compensation adjusts the light intensity of the two beams while the wavelength is scanned. The active adjustment of the incident light spectrum pre-compensates the strong solvent absorption to equally maximize the dynamic range of the detection system over the entire spectral range. Exemplary embodiments can enhance the SNR of the spectrometer significantly, particularly for the analyte peaks near the solvent absorption bands.

According to one aspect of the invention, a spectrum adjuster to produce a pure analyte spectrum of a sample includes a digital micromirror device that: receives input light, receives an adjustment signal, and produces primary adjusted light from the input light based on the adjustment signal such that an intensity of the primary adjusted light is based on an amount of primary transmitted light transmitted through the sample in an absence of an analyte; a light source in optical communication with the digital micromirror device and that communicates the input light to the digital micromirror device; a detector in optical communication with the digital micromirror device that: receives transmitted light from the sample, and produces a transmitted light signal based on an amount of transmitted light received from the sample; and an adjustment controller in communication with the detector and the digital micromirror device and that: receives the transmitted light signal from the detector, produces the adjustment signal based on the transmitted light signal, and communicates the adjustment signal to the digital micromirror device; the digital micromirror device being optically interposed between the light source and the detector, and the sample when present being optically interposed between the digital micromirror device and the detector.

Optionally, the spectrum adjuster includes a spectrum analyzer in communication with the detector and that: receives the transmitted light signal from the detector; and determines the pure analyte spectrum of the analyte.

Optionally, the digital micromirror device controls an intensity of the primary adjusted light based on the adjustment signal by controlling a number of micromirrors of the digital micromirror device reflecting input light optically downstream towards the sample.

Optionally, the digital micromirror device increases the intensity of the primary adjusted light relative to a previous intensity of the primary adjusted light at a wavelength of the input light at which the sample in absence of the analyte absorbs greater than or equal to 80% of the primary adjusted light.

According to another aspect of the invention, a double beam spectrometer includes a digital micromirror device that: receives input light, receives a splitting signal, splits the input light into a reference light signal and a sample light signal, wherein the reference light signal and sample light signal are inherently intensity-modulated with reference to each other and out of phase with each other by micromirrors of the digital micromirror device switching back and forth reflecting input light either towards a sample or towards a detector; a light source in optical communication with the digital micromirror device and that communicates the input light to the digital micromirror device; a detector in optical communication with the digital micromirror device that: receives a transmitted light signal from the sample and the reference light signal from the digital micromirror device, and measures a modulation signal based on a combination of the transmitted light and the reference light signal; and an adjustment controller in communication with the digital micromirror device that: produces the splitting signal, and communicates the splitting signal to the digital micromirror device, the digital micromirror device being optically interposed between the light source and the detector, and the sample when present being optically interposed between the digital micromirror device and the detector and wherein the transmitted light signal is created by passing the sample light signal through the sample.

Optionally, an intensity of the transmitted light and an intensity of the reference signal are equal when the sample does not contain an analyte.

Optionally, an intensity of the transmitted light and an intensity of the reference signal differ by no more than twenty-five percent when the sample does not contain an analyte.

The foregoing and other features of the invention are hereinafter described in greater detail with reference to the accompanying drawings.

### BRIEF DESCRIPTION OF THE DRAWINGS

FIG. 1 shows, according to some embodiments, a digital micromirror device (DMD) and its operation to control the intensity and direction of a reflected beam. The angle of the mirrors determines the direction, and the number of the reflecting mirrors controls the light intensity of the reflected beam.

FIG. 2 shows a conventional approach based on multiple acousto-optic modulators (AOM) or their associated optical components to control the spectrum of non-modulated double beams.

FIG. 3 shows an embodiment of this invention to non-modulated double-beam spectrometry that uses only one digital micromirror device (DMD) to simultaneously control the spectrum of both beams.

FIG. 4 shows a conventional AOM-based approach to double-beam modulation spectrometry. The dashed lines indicate the on-off intensity modulation of double beams.

FIG. 5 shows an embodiment of the invention for a DMD-based approach to double-beam modulation spectrometry. The dashed lines indicate the on-off intensity modulation of double beams.

FIG. 6 shows, according to some embodiments, a computing system for operation, control, analysis, or data acquisition.

FIG. 7 shows an embodiment of this invention that uses a digital micromirror device (DMD) to control the spectrum of the sample beam.

FIG. 8 shows an embodiment of the invention for a DMD-based approach to double-beam modulation spectrometry.

FIG. 9 shows an illustration of the modulation of signals according to the embodiment of FIG. 8.

### DETAILED DESCRIPTION

A detailed description of one or more embodiments is presented herein by way of exemplification and not limitation.

A double-beam path configuration can improve the signal-to-noise ratio (SNR) of a spectrometer by measuring the ratio or the difference between the sample path and the reference path signals. A beam from a single light source is split into two beams, wherein one beam passes through a sample while the other passes through a reference. By detecting the two beam signals simultaneously, one can eliminate the common signal fluctuations in the two beams and measure only the analyte signals in the sample path. In some applications, wavelength-scanning monochromatic light is used as the light source for a double-beam spectrometer. An absorption or transmission spectrum can be measured by detecting the two beam signals with fast and sensitive single-element detectors while the wavelength is scanned.

However, when a solvent has a strong absorption at a narrow wavelength range, the limited dynamic range of the detection system cannot cover the entire wavelength range of a spectrum, resulting in extremely poor SNR at the solvent-absorbing wavelength range. Some technology for solvent absorption compensation (SAC) disclosed in U.S. Pat. No. 10,345,226, the disclosure of which is incorporated by reference herein in its entirety, adjusts the light intensity of the two beams while the wavelength is scanned. The active adjustment of the incident light spectrum pre-compensates the strong solvent absorption to equally maximize the dynamic range of the detection system over the entire spectral range. The SAC technique can enhance the SNR of the spectrometer significantly, particularly for the analyte peaks near the solvent absorption bands. Chon et al., Analytical Chemistry, 93, 2215 (2021), the disclosure of which is incorporated by reference herein in its entirety, discloses a set of acousto-optic modulators adjusts the light intensity of the two beams while the wavelength is rapidly scanned.

A conventional double-beam approach uses two detectors, one for each beam path. However, in some spectrometer systems, detectors can be a significant noise source. For example, a mercury-cadmium-telluride (MCT) detector is widely used for mid-and far-infrared (IR) spectroscopy but accompanies significant thermal noise. Thus, typical IR light detectors require additional cooling units, such as a thermoelectric cooler or liquid nitrogen. Still, the thermal fluctuation of an IR detector is significant, and the uncorrelation thermal fluctuation of two separate IR detectors becomes non-negligible for a double-beam IR spectrometer. An optical double-beam modulation (DBM) on-off modulates two beams and detects the signal with a single detector in some conventional art. Kim et al., Scientific Reports, 13, (2023), the disclosure of which is incorporated by reference herein in its entirety, discloses a set of AOMs that simultaneously modulate the two beams while the AOMs control the spectra of the two beams rapidly. The results show that the DBM method improves the SNR by more than tenfold.

SAC and DBM are based on acousto-optic modulators, which can control the light intensity rapidly with a great dynamic range. However, the diffraction efficiency of an AOM is equal to or lower than 70% per single pass, and <50% for two passes. Also, the space taken by an AOM and its accompanying mirrors is significant, making it difficult to construct a compact spectrometer system. Most of all, the normal operation of an AOM generates heat, which needs to be dissipated by circulating water with an external chiller. Even small temperature fluctuations can cause unwanted signal drift, which is unpredictable and difficult to remove from a measured spectrum. These instrumental challenges associated with using AOMs can increase the system instability and the production cost of a spectrometer.

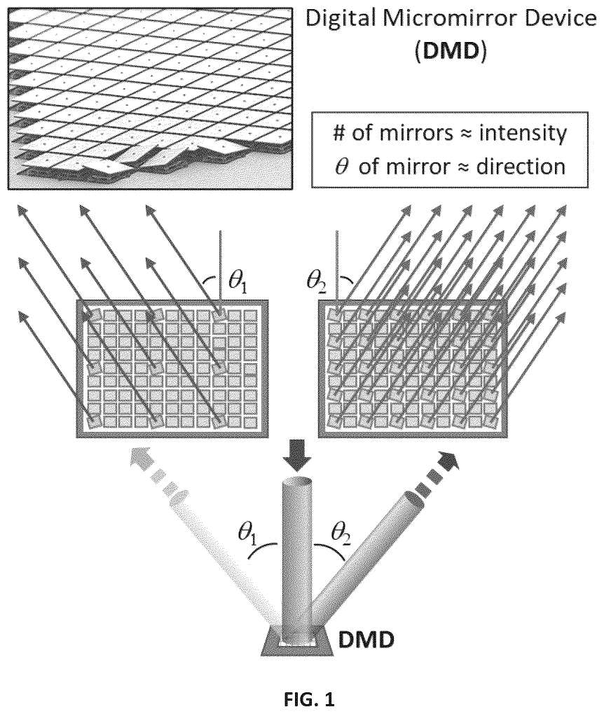

Embodiments of the invention may replace multiple, bulky AOM units with a single digital micromirror device (DMD). A DMD chip has several hundred thousand microscopic mirrors, as shown in FIG. 1. The angle of micromirrors can be controlled individually by computer programming. The number of mirrors reflecting in one direction determines the reflected beam intensity. For a double-beam spectrometer, a fraction of mirrors directs the beam in the sample direction, and another fraction of mirrors direct the beam in the reference direction.

Double-beam absorption spectrometry compares transmission spectra through a sample and a reference to minimize the common-mode noise of the system. A light intensity controller, laser scanning double-beam spectrometer, and laser scanning are described herein and include an optical method that maximizes signal-to-noise ratio by employing a digital micromirror device (DMD) that modulates the light intensity of double laser beams.

In some conventional mid-infrared (IR) spectroscopy, solvent absorption compensation (SAC) and double-beam modulation (DBM) improved the SNR. This conventional technology unfortunately includes multiple acousto-optic modulators (AOM) in a SAC-DBM-IR spectrometer that requires a large space and makes the spectrometer bulky. Also, this conventional technology unfortunately suffers because the transmission fluctuation occurs in the AOMs and produces signal drift.

The light intensity controller, laser scanning double-beam spectrometer, and laser scanning overcome these deficiencies of this conventional technology. In some embodiments, the conventional multiple AOMs are substituted by a single DMD chip that significantly reduces the entire system space and eliminates the signal drift due to two-beam intensity fluctuation. The binary (on-off) intensity of double beams can be modulated for DBM by alternating the reflection angle, and the grayscale intensity of each beam can be adjusted for SAC by controlling the number of micromirror elements aimed at the direction. Embodiments increase the light power, provide a compact system, reduce system fluctuation, and lower the detection limit of analytes.

Embodiments can include optimization of a double-beam modulation scheme. It is contemplated that a mechanical chopper (e.g., a pair) and acousto-optic modulators (e.g., a pair) can be included to provide phase-controlled modulation of double beams. Further, embodiments can be subjected to optimization for a wide wavelength range or fast acquisition speed.

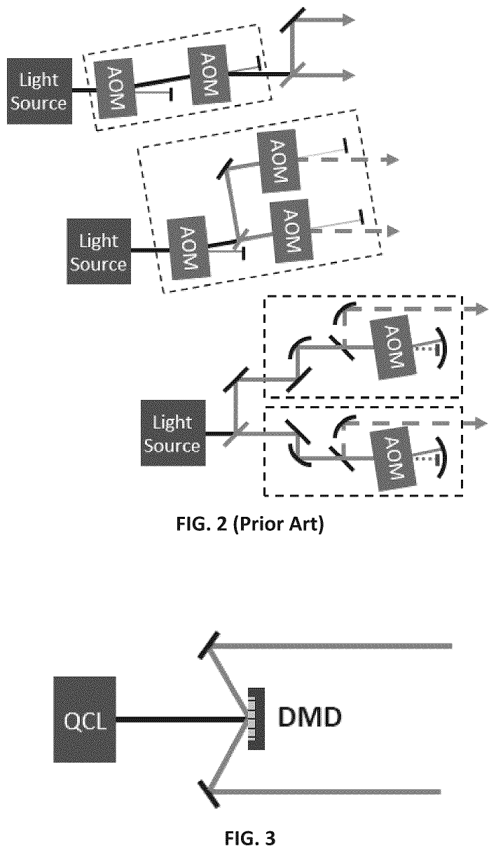

FIG. 2 shows the double-beam configurations used by previously demonstrated AOM-based QCL-IR spectrometers. These non-modulated configurations can be used for the SAC-only spectrometer, where the spectrum of the incident light is adjusted by single-pass AOMs or a double-pass AOM before it is split into two beams. In contrast, in FIG. 3, the new DMD-based method uses only a single DMD to control the spectra of both beams.

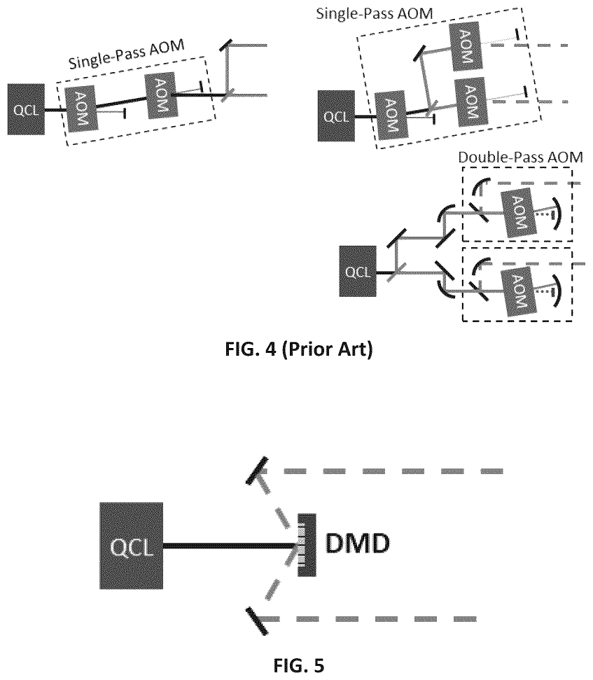

FIGS. 4 and 5 show the comparison of the AOM-based and DMD-based approaches to DBM spectrometry. For the simultaneous control of the intensity and the on-off modulation, an AOM-based spectrometer will require at least one AOM for each beam, making the double-beam system bulkier (FIG. 4). In contrast, a single DMD can control both the intensity (the number of mirrors) and the on-off modulation (the angle of mirrors) simultaneously (FIG. 5).

The dynamic range of the intensity control of each beam will be proportional to the number of irradiated mirrors. The maximum double-beam modulation frequency will be limited by the maximum operation frequency of a DMD chip.

DMD provides image projection and display. Some conventional DMD-related technologies provide image-transferring optical components. Light modulation using a DMD is also related to image transfer. The on-off of an image pixel can be controlled by the binary direction of a mirror toward the display screen. Embodiments of the invention include the number of pixels being used to control the light intensity of double beams and the alternation of the mirror angle modulates the on-off beam out of phase to each other beam.

Embodiments can include a DMD unit and controller and a double beam spectrometer system, which includes a light source, a sample cell, a reference cell, a detector, a preamplifier, a lock-in amplifier, and a controlling program and computer interface.

Embodiments can include a DMD window that can be removed. The incident beam diameter can be expanded to fill the DMD active area for the maximum dynamic range for intensity control (see FIG. 1).

Embodiments can include a fast double-beam modulation to eliminate the common-mode noise for a broader frequency range. Embodiments can include a three-angle setting that can include one for the sample beam; another for the reference; and the other for the beam dump.

Embodiments can include a SAC-only double-beam spectrometer as shown in FIG. 3. Here, the dynamic resolution is obtained by controlling the number of mirrors for SAC operation, wherein the mirrors can be modulated binarily for DBM-SAC operation. Optimization of the optical system can occur for tuning SNR.

Light intensity controller 200 can be made of various elements and components that are fabricated or obtained from a vendor. Elements of light intensity controller 200 can be of various sizes. Elements of light intensity controller 200 can be made of a material that is physically or chemically resilient in an environment in which light intensity controller 200 is disposed. Exemplary materials include a metal, ceramic, thermoplastic, glass, semiconductor, and the like. The elements of light intensity controller 200 can be made of the same or different material and can be monolithic in a single physical body or can be separate members that are physically joined.

Light intensity controller 200 can be made in various ways. It should be appreciated that light intensity controller 200 includes a number of optical, electrical, or mechanical components, wherein such components can be interconnected and placed in communication (e.g., optical communication, electrical communication, mechanical communication, and the like) by physical, chemical, optical, or free-space interconnects. The components can be disposed on mounts that can be disposed on a bulkhead for alignment or physical compartmentalization. As a result, light intensity controller 200 can be disposed in a terrestrial environment or space environment. Elements of light intensity controller 200 can be formed from silicon, silicon nitride, and the like although other suitable materials, such ceramic, glass, or metal can be used. According to an embodiment, the elements of light intensity controller 200 are formed using 3D printing although the elements of light intensity controller 200 can be formed using other methods, such as injection molding or machining a stock material such as block of material that is subjected to removal of material such as by cutting, laser oblation, and the like. Accordingly, light intensity controller 200 can be made by additive or subtractive manufacturing. In an embodiment, elements of light intensity controller 200 are selectively etched to remove various different materials using different etchants and photolithographic masks and procedures. The various layers thus formed can be subjected to joining by bonding to form light intensity controller 200.

It is contemplated that light intensity controller 200 can include the properties, functionality, hardware, and process steps described herein and embodied in any of the following non-exhaustive list:
a process (e.g., a computer-implemented method including various steps; or a method carried out by a computer including various steps);
an apparatus, device, or system (e.g., a data processing apparatus, device, or system including means for carrying out such various steps of the process; a data processing apparatus, device, or system including means for carrying out various steps; a data processing apparatus, device, or system including a processor adapted to or configured to perform such various steps of the process);
a computer program product (e.g., a computer program product including instructions which, when the program is executed by a computer, cause the computer to carry out such various steps of the process; a computer program product including instructions which, when the program is executed by a computer, cause the computer to carry out various steps);
computer-readable storage medium or data carrier (e.g., a computer-readable storage medium including instructions which, when executed by a computer, cause the computer to carry out such various steps of the process; a computer-readable storage medium including instructions which, when executed by a computer, cause the computer to carry out various steps; a computer-readable data carrier having stored thereon the computer program product; a data carrier signal carrying the computer program product);
a computer program product including instructions which, when the program is executed by a first computer, cause the first computer to encode data by performing certain steps and to transmit the encoded data to a second computer; or
a computer program product including instructions which, when the program is executed by a second computer, cause the second computer to receive encoded data from a first computer and decode the received data by performing certain steps.

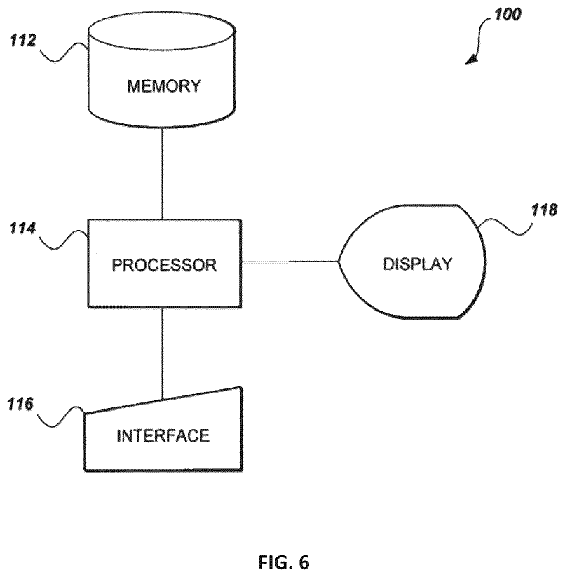

It should be understood that the calculations may be performed by any suitable computer system, such as that diagrammatically shown in FIG. 6. Data is entered into system 100 via any suitable type of user interface 116, and may be stored in memory 112, which may be any suitable type of computer readable and programmable memory and is preferably a non-transitory, computer readable storage medium. Calculations are performed by processor 114, which may be any suitable type of computer processor and may be displayed to the user on display 118, which may be any suitable type of computer display. Processor 114 may be associated with, or incorporated into, any suitable type of computing device, for example, a personal computer or a programmable logic controller. The display 118, the processor 114, the memory 112 and any associated computer readable recording media are in communication with one another by any suitable type of data bus, as is well known in the art.

Examples of computer-readable recording media include non-transitory storage media, a magnetic recording apparatus, an optical disk, a magneto-optical disk, and/or a semiconductor memory (for example, RAM, ROM, etc.). Examples of magnetic recording apparatus that may be used in addition to memory 112, or in place of memory 112, include a hard disk device (HDD), a flexible disk (FD), and a magnetic tape (MT). Examples of the optical disk include a DVD (Digital Versatile Disc), a DVD-RAM, a CD-ROM (Compact Disc-Read Only Memory), and a CD-R (Recordable)/RW. It should be understood that non-transitory computer-readable media include all computer-readable media except for a transitory, propagating signal.

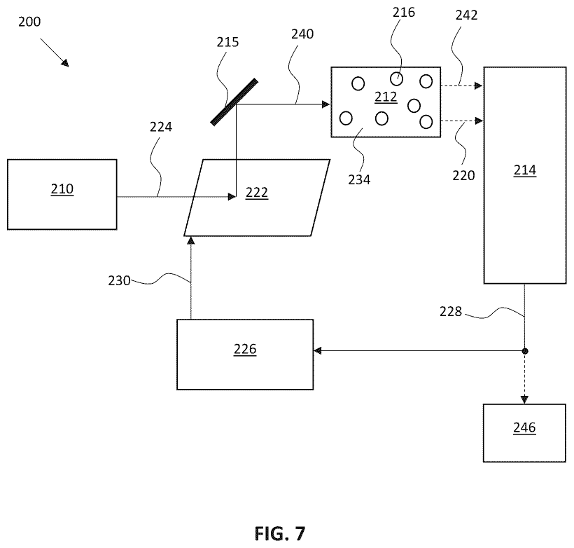

Turning now to FIG. 7, a spectrum adjuster 200, in accordance with the invention, includes digital micromirror device (DMD) 222. DMD 222 receives input light 224, receives adjustment signal 230, and produces primary adjusted light 240 from input light 224 based on adjustment signal 230. An intensity of primary adjusted light 240 is based on an amount of primary transmitted light 242 transmitted through sample 212 in an absence of analyte 216. Spectrum adjuster 200 also includes light source 210 in optical communication with DMD 222 that communicates input light 224 to DMD 222. Detector 214 is in optical communication with DMD 222 and receives secondary transmitted light 220 from sample 212 in the presence of analyte 216 and produces transmitted light signal 228 based on an amount of secondary transmitted light 220 received from sample 212. Adjustment controller 226 is in communication with detector 214 and DMD 222. Here, adjustment controller 226 receives transmitted light signal 228 from detector 214, produces adjustment signal 230 based on transmitted light signal 228, and communicates adjustment signal 230 to DMD 222. DMD 222 is optically interposed between light source 210 and detector 214. Sample 212, when present, is optically interposed between DMD 222 and detector 214.

Spectrum adjuster 200 can include spectrum analyzer 246 in communication with detector 214. Spectrum analyzer 246 receives transmitted light signal 228 from detector 214 and determines pure analyte spectrum of analyte 216.

Spectrum adjuster 200 produces adjusts an amount of light subjected to sample 212. Spectrum adjuster 200 includes light source 210 that can include components to generate incident light that can be transferred through a free space or through a set of optical components, such as lenses and fiber optics. In an embodiment, light source 210 includes external cavity quantum cascade lasers that generate mid-infrared light.

Light source 210 produces input light 224 that has an intensity as a function of wavelength. The wavelength can be from 200 nm to 20000 nm, specifically from 2500 nm to 10000 nm, and more specifically from 5700 nm to 6700 nm. An intensity of input light 224 can be characterized by optical power, which can be from 200 nm to 20000 nm, specifically from 2500 nm to 10000 nm, and more specifically from 5700 nm to 6700 nm. Moreover, input light 224 can produce monochromatic light or broadband continuum light and be operated as a pulsed mode or a continuous-wave mode. In an embodiment, input light 224 produces monochromatic light scanning from 6500 nm to 11000 nm in a pulsed mode with the bandwidth of 1 cm⁻¹, the repetition rate of 100 kHz, and the duty cycle of 5%.

Sample 212 can include matrix 234, analyte 216, or a combination thereof. Sample 212 can also include solvent and analytes that are dissolved in the solvent to measure the concentration of the analyte and can be solid matrix containing analytes that are dispersed in the matrix. In an embodiment, sample 212 includes an aqueous solution of protein.

Detector 214 can convert the light signal of secondary transmitted light 220 or primary transmitted light 242 into transmitted light signal 228. In an embodiment, detector 214 includes a mercury-cadmium-telluride detector, a pyroelectric detector, an indium arsenide detector, an indium antimonide detector, a silicon photodiode, an indium gallium arsenide detector, a photomultiplier, or the like.

Analyte 216 can be mixed with matrix 234 in sample 212. In an embodiment, analyte 216 includes protein, polymer, carbohydrate, mineral, and the like.

Primary transmitted light 242 can include infrared light, visible light, ultraviolet light, and the like.

DMD 222 can alternatively modify transmission of input light 224 into a sample light signal 240 and a reference light signal 218 based on a splitting signal 230.

Input light 224 can be generated by light source 210. In an embodiment, input light 224 includes infrared light, visible light, ultraviolet light, or the like.

Transmitted light signal 228 can be generated by detector 214 in response to secondary transmitted light 220 or primary transmitted light 242. In an embodiment, transmitted light signal 228 includes electrical voltage, electrical current, light intensity, or the like.

Adjustment signal 230 can be generated by adjustment controller 226 in response to transmitted light signal 228. In an embodiment, adjustment signal 230 includes electrical voltage, electrical current, light intensity, or the like.

Pure analyte spectrum can be generated by spectrum analyzer 246 in response to transmitted light signal 228. In an embodiment, pure analyte spectrum 232 includes a transmission spectrum, an absorption spectrum, a reflectance spectrum, an intensity spectrum, or the like.

Matrix 234 can be mixed with analyte 216 in sample 212. In an embodiment, matrix 234 includes a liquid solvent, hydrogel, vapor, solid matrix, or the like.

Primary adjusted light 240 can be light transmitted by DMD 222. In an embodiment, primary adjusted light 240 includes infrared light, visible light, ultraviolet light, and the like.

Primary transmitted light 242 can be primary adjusted light 240 transmitted by sample 212 containing matrix 234 in the absence of analyte 216. In an embodiment, primary transmitted light 242 includes infrared light, visible light, ultraviolet light, or the like.

Spectrum analyzer 246 can generate pure analyte spectrum in response to transmitted light signal 228. In an embodiment, spectrum analyzer 246 includes a computer, a digital-to-analog converter, an oscilloscope, a recording device, or the like.

Spectrum adjuster 200 can be made in various ways. In an embodiment, a process for making spectrum adjuster 200 includes disposing light source 210 in optical communication with DMD 222; disposing adjustment controller 226 in electrical communication with DMD 222; disposing DMD 222 in communication with detector 214; and disposing detector 214 in communication with adjustment controller 226. Analyte 216 can be interposed between and in optical communication with DMD 222 and detector 214.

In the process for making spectrum adjuster 200, disposing light source 210 in optical communication with DMD 222 can include directing the light from light source 210 using mirrors and lenses in free space to DMD 222. Disposing light source 210 in optical communication with DMD 222 can also include attaching an optical fiber to a light outlet port of a laser that operates as light source 210 and connecting the free end of the optical fiber to DMD 222. In an embodiment, metallic mirrors direct the light from a laser to the input port of DMD 222.

In the process for making spectrum adjuster 200, disposing adjustment controller 226 in electrical communication with DMD 222 can include connecting electrical cables and optical fibers from adjustment controller 226 to DMD 222.

In the process for making spectrum adjuster 200, disposing DMD 222 in communication with detector 214 can include directing the light from DMD 222 using mirrors 215 and lenses in free space to sample 212 and then directing the light from sample 212 using mirrors and lenses in the free space to detector 214. Disposing DMD 222 in communication with detector 214 can also include directing the light using fiber optics from DMD 222 to sample 212 and to detector 214. In an embodiment, light from DMD 222 is directed by metallic mirrors to the transmission path of sample 212 and focused by a lens to the active area of detector 214.

In the process for making spectrum adjuster 200, disposing detector 214 in communication with spectrum analyzer 246 can include connecting electrical cables and optical fibers from detector 214 to spectrum analyzer 246.

In the process for making spectrum adjuster 200, disposing spectrum analyzer 246 in communication with adjustment controller 226 can include connecting electrical cables and optical fibers from spectrum analyzer 246 to adjustment controller 226.

In the process for making spectrum adjuster 200, interposing analyte 216 between and in optical communication with DMD 222 and detector 214 can include placing analyte 216 into sample 212 that is positioned between DMD 222 and detector 214. In an embodiment, a solution containing matrix 234 and analyte 216 replaces a solution containing only matrix 234 in the absence of analyte 216 in sample 212.

Sample 212 can be made by introducing a matrix or a combination of matrix and analyte in a sample containing a cell and locating the sample in optical communication between DMD 222 and detector 214.

Making individual components of spectrum adjuster 200 can be accomplished using, e.g., additive manufacturing, mechanical machining, and the like. Components can be joined together by mechanical joints, chemical adhesives, and free contacts. Alignment of individual components can be performed by automatic feedback or manually.

It is contemplated that making spectrum adjuster 200 can include a process by which DMD 222 is produced at a remote site, received by a user, and subsequently used to obtain secondary transmitted light 220 and pure analyte spectrum. In an embodiment, a process for making DMD 222 at a remote site includes disposing light source 210 in optical communication with DMD 222; disposing adjustment controller 226 in electrical communication with DMD 222; disposing DMD 222 in communication with detector 214; disposing detector 214 in communication with adjustment controller 226; interposing sample 212 containing matrix 234 between and in optical communication with dynamic opacity optic 222 and detector 214.

In an embodiment, a process for producing pure analyte spectrum includes: producing input light 224; receiving, by DMD 222, input light 224; producing, by DMD 222, primary adjusted light 240 from input light 224 by adjusting the number of micro-mirrors of DMD reflecting input light 224 towards sample 212; subjecting sample 212 in absence of analyte 216 to primary adjusted light 240; communicating, from sample, primary transmitted light 242, in response to subjecting sample 212 in absence of analyte 216 to primary adjusted light 240; receiving, by detector 214, primary transmitted light 242; producing, by detector 214, transmitted light signal 228 based on primary transmitted light 242; receiving, by adjustment controller 226, transmitted light signal 228 from detector 214; producing, by adjustment controller 226, adjustment signal 230 based on transmitted light signal 228; communicating adjustment signal 230 from adjustment controller 226 to DMD 222; and producing, by DMD 222, an altered primary adjusted light 240 based on adjustment signal 230; subjecting sample 212 comprising analyte 216 to primary adjusted light 240; communicating, from sample 212, secondary transmitted light 220 in response to subjecting sample 212 in presence of analyte 216 to primary adjusted light 240; receiving, by detector 214, secondary transmitted light 220; producing, by detector 214, transmitted light signal 228 based on secondary transmitted light 220; receiving, by spectrum analyzer 246, transmitted light signal 228 from detector 214; and converting transmitted light signal 228 into pure analyte spectrum to produce pure analyte spectrum.

The process for producing pure analyte spectrum can include controlling an intensity of primary adjusted light 240 based on adjustment signal 230. In the process for producing pure analyte spectrum, controlling intensity of primary adjusted light 240 based on adjustment signal 230 can include increasing, by DMD 222, intensity of primary adjusted light 240 relative to an intensity of a previous instance of primary adjusted light 240 at a wavelength of input light 224 at which sample 212 in absence of analyte 216 absorbs greater than or equal to 80% of primary adjusted light 240. In order to effectuate this increase in intensity, DMD 222 increases the number of micromirrors of the DMD that reflect input light 224 towards sample 212.

It is contemplated that in the process for producing pure analyte spectrum, producing input light 224 can include generating light from light source 210 and controlling conditions of the light including wavelength, intensity, and bandwidth.

In the process for producing pure analyte spectrum, receiving, by DMD 222, input light 224 can include transmitting, refracting, and reflecting input light 224 by reflective and refractive optical components in free space or by optical fibers to the entrance of DMD 222.

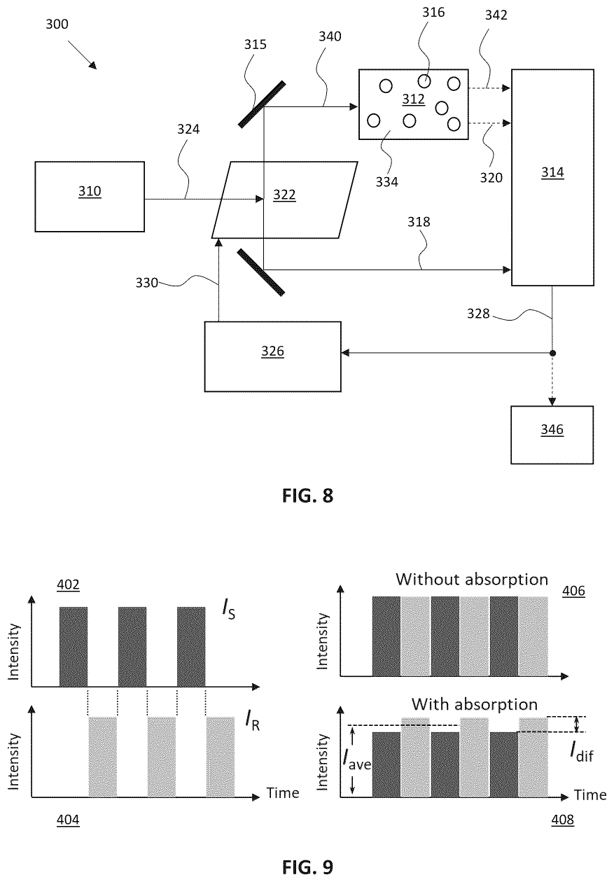

Turning now to FIG. 8, an exemplary embodiment of a double-beam spectrometer is shown at 300. The double beam spectrometer 300 is substantially the same as the above-referenced spectrum adjuster 200, and consequently, the same reference numerals but indexed by 100 are used to denote structures corresponding to similar structures. In addition, the foregoing description of the spectrum adjuster 200 is equally applicable to the double-beam spectrometer 300 except as noted below. Moreover, it will be appreciated upon reading and understanding the specification that aspects of the embodiments may be substituted for one another or used in conjunction with one another where applicable.

The DMD 322 can modify the transmission of input light 324 into a sample light signal 340 and a reference light signal 318 based on a splitting signal 330. In this alternative embodiment, the DMD controls a plurality of micromirrors to alternately direct light toward the sample and to the detector (optionally by way of a reference cell (not shown). The

The light intensities I_{S} and I_{R} of the sample light signal 340 and the reference light signal 318, respectively, of two beams are adjusted to be the same as shown on the left side of FIG. 9 in graphs 402 and 404. In the absence of analytes, the intensity of the combined signals appears to be constant as shown in graph 406. If light is absorbed by the analytes, the reduced transmission of the transmitted signal 320 will cause the detected combined signal to be as shown in graph 408, resulting in an intensity difference, I_{dif}, and an intensity average, Iₐᵥₑ. The signal change processed by the spectrum analyzer 346 can be converted to transmittance or absorbance. If the transmittance or the absorbance is measured as a function of the wavelength of the incident light, it can generate a transmission spectrum or an absorption spectrum of the analytes.

Preferably, an intensity of the transmitted light 342 and an intensity of the reference light signal 318 differ by no more than twenty-five percent when the sample 312 does not contain an analyte 316. More preferably, an intensity of the transmitted light 342 and an intensity of the reference light signal 318 are equal when the sample 312 does not contain an analyte 316. When an analyte is present, the transmitted light 320 will differ from the reference light signal, and, when combined with each other, the detector 314 will pass the combined signal 328 to the spectrum analyzer 346, which will measure the modulation of the combined signal to determine the analyte spectrum.

The processes described herein may be embodied in, and fully automated via, software code modules executed by a computing system that includes one or more general purpose computers or processors. The code modules may be stored in any type of non-transitory computer-readable medium or other computer storage device. Some or all the methods may alternatively be embodied in specialized computer hardware. In addition, the components referred to herein may be implemented in hardware, software, firmware, or a combination thereof.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

Any logical blocks, modules, and algorithm elements described or used in connection with the embodiments disclosed herein can be implemented as electronic hardware, computer software, or combinations of both. To clearly illustrate this interchangeability of hardware and software, various illustrative components, blocks, modules, and elements have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described or used in connection with the embodiments disclosed herein can be implemented or performed by a machine, such as a processing unit or processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A processor can be a microprocessor, but in the alternative, the processor can be a controller, microcontroller, or state machine, combinations of the same, or the like. A processor can include electrical circuitry configured to process computer-executable instructions. In another embodiment, a processor includes an FPGA or other programmable device that performs logic operations without processing computer-executable instructions. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

The elements of a method, process, or algorithm described in connection with the embodiments disclosed herein can be embodied directly in hardware, in a software module stored in one or more memory devices and executed by one or more processors, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An example storage medium can be coupled to the processor such that the processor can read information from, and write information to, the storage medium. In the alternative, the storage medium can be integral to the processor. The storage medium can be volatile or nonvolatile.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix(s) as used herein is intended to include both the singular and the plural of the term that it modifies, thereby including at least one of that term (e.g., the colorant(s) includes at least one colorants). Option, optional, or optionally means that the subsequently described event or circumstance can or cannot occur, and that the description includes instances where the event occurs and instances where it does not. As used herein, combination is inclusive of blends, mixtures, alloys, reaction products, collection of elements, and the like.

As used herein, a combination thereof refers to a combination comprising at least one of the named constituents, components, compounds, or elements, optionally together with one or more of the same class of constituents, components, compounds, or elements.

All references are incorporated herein by reference.

The use of the terms “a,” “an,” and “the” and similar referents in the context of describing the invention (especially in the context of the following claims) are to be construed to cover both the singular and the plural, unless otherwise indicated herein or clearly contradicted by context. It can further be noted that the terms first, second, primary, secondary, and the like herein do not denote any order, quantity, or importance, but rather are used to distinguish one element from another. It will also be understood that, although the terms first, second, etc. are, in some instances, used herein to describe various elements, these elements should not be limited by these terms. For example, a first current could be termed a second current, and, similarly, a second current could be termed a first current, without departing from the scope of the various described embodiments. The first current and the second current are both currents, but they are not the same condition unless explicitly stated as such.

The modifier about used in connection with a quantity is inclusive of the stated value and has the meaning dictated by the context (e.g., it includes the degree of error associated with measurement of the particular quantity). The conjunction or is used to link objects of a list or alternatives and is not disjunctive; rather the elements can be used separately or can be combined together under appropriate circumstances.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

What is claimed is:

1. A spectrum adjuster to produce a pure analyte spectrum of a sample, the spectrum adjuster comprising:
a digital micromirror device that:
receives input light;
receives an adjustment signal;
produces primary adjusted light from the input light based on the adjustment signal such that an intensity of the primary adjusted light is based on an amount of primary transmitted light transmitted through the sample in an absence of an analyte;
a light source in optical communication with the digital micromirror device and that communicates the input light to the digital micromirror device;
a detector in optical communication with the digital micromirror device that:
receives transmitted light from the sample; and
produces a transmitted light signal based on an amount of transmitted light received from the sample; and
an adjustment controller in communication with the detector and the digital micromirror device and that:
receives the transmitted light signal from the detector;
produces the adjustment signal based on the transmitted light signal; and
communicates the adjustment signal to the digital micromirror device,
the digital micromirror device being optically interposed between the light source and the detector, and the sample when present being optically interposed between the digital micromirror device and the detector.

2. The spectrum adjuster of claim 1, further comprising a spectrum analyzer in communication with the detector and that:
receives the transmitted light signal from the detector; and
determines the pure analyte spectrum of the analyte.

3. The spectrum adjuster of claim 1, wherein the digital micromirror device controls an intensity of the primary adjusted light based on the adjustment signal by controlling a number of micromirrors of the digital micromirror device reflecting input light optically downstream towards the sample.

4. The spectrum adjuster of claim 3, wherein the digital micromirror device increases the intensity of the primary adjusted light relative to a previous intensity of the primary adjusted light at a wavelength of the input light at which the sample in absence of the analyte absorbs greater than or equal to 80% of the primary adjusted light.

5. A double beam spectrometer comprising:
a digital micromirror device that:
receives input light;
receives a splitting signal;
splits the input light into a reference light signal and a sample light signal, wherein the reference light signal and sample light signal are inherently intensity-modulated with reference to each other and out of phase with each other by micromirrors of the digital micromirror device switching back and forth reflecting input light either towards a sample or towards a detector;
a light source in optical communication with the digital micromirror device and that communicates the input light to the digital micromirror device;
a detector in optical communication with the digital micromirror device that:
receives a transmitted light signal from the sample and the reference light signal from the digital micromirror device; and
measures a modulation signal based on a combination of the transmitted light and the reference light signal; and
an adjustment controller in communication with the digital micromirror device that:
produces the splitting signal; and
communicates the splitting signal to the digital micromirror device,
the digital micromirror device being optically interposed between the light source and the detector, and the sample when present being optically interposed between the digital micromirror device and the detector and wherein the transmitted light signal is created by passing the sample light signal through the sample.

6. The double beam spectrometer of claim 5, wherein an intensity of the transmitted light and an intensity of the reference signal are equal when the sample does not contain an analyte.

7. The double beam spectrometer of claim 5, wherein an intensity of the transmitted light and an intensity of the reference signal differ by no more than twenty-five percent when the sample does not contain an analyte.
